(19) United States
(12) Patent Application Publication
(10) Pub. No.: US 2002/0119221 A1
(43) Pub. Date: Aug. 29, 2002

(54) Food package and method and device for extrusion of food

(76) Inventors: Humiaki Matsukura, Saitama-ken (JP); Naoki Morishige, Saitama-ken (JP); Hirotaka Sasaki, Saitama-ken (JP)

Correspondence Address: BIRCH STEWART KOLASCH & BIRCH, PO BOX 747, FALLS CHURCH, VA, 22040-0747, US

(21) Appl. No.: 10/015,599

(22) Filed: Dec. 17, 2001

(30) Foreign Application Priority Data
Dec. 19, 2000 (JP) 2000-385353
Dec. 19, 2000 (JP) 2000-385354

(51) Int. Cl. A23B 4/00

(52) U.S. Cl. 426/115

(57) ABSTRACT

Food package according to the present invention comprises a container made of soft material and having a trunk substantially shaped in a cylinder, a truncated cone or an inverted truncated cone, and a bottom formed in its substantially central zone with a push-out aperture provided with a removable seal, and filled with viscous or semisolid food wherein the container has a sealed upper opening. Push-out method for food from such food package comprises steps as follow: providing a push-out device comprising a container receiving member having a substantially cylindrical trunk member and a bottom member provided in its central zone with a through-hole, and a depressing member adapted to be guided into the cylindrical trunk member from above; setting the food package according to claim 1 in the container receiving member; compressing the food package by the depressing member from above toward the bottom while the container made of soft material is controllably guided along the inner surface of the cylindrical trunk member or a peripheral surface of the through-hole of the bottom member so that the container may be prevented from shifting sideways until the container is flattened; and thereby forcing out the content food through the push-out aperture and the through-hole of the bottom of the container made of soft material.

### TECHNICAL BACKGROUND

The present invention relates to a food package comprising a container made of soft material, which is provided at its bottom with a push-out aperture and filled with viscous or semisolid food (referred to hereinafter simply as food unless otherwise specified) such as ice cream, ice milk or frozen yogurt and also to a method for pushing the content out from this food package using a push-out device.

### DESCRIPTION OF THE RELATED ART

Conventionally, so-called dish-up type of such food, for example, ice cream or frozen yogurt has been well known, which is distributed in bulk and, for sale on a counter, dispensed by a scoop into individual containers.

The food frozen and distributed in bulk must be necessarily stored in solid state prior to be actually served on the counter. This means that a considerable force must be exerted on the scoop or the like to dispense the food into the individual containers. Thus, operation of dispense is not easy and, as a result, the dispensed quantity of food may be uneven.

The food not scooped but filled into individual containers to be served on the counter is often the food having certain flowability. The food of this type requires appropriate filling equipment including a nozzle through which the food is dispensed. To meet the sanitary requirements, the equipment must be often rinsed.

In such situation, various systems of distributing and selling food such as dish-up type ice cream have been proposed.

For example, Japanese Laid-Open PCT Application Gazette No. 1986-508157 discloses a method comprising steps as following: providing a container of cone-, truncated cone- or truncated pyramid-shape on its bottom side with a push-out aperture; dimensioning a foldable lid to extend to the bottom side of the container; telescopically placing the lid and the container upon each other after the container has been filled with ice cream; and forcing the content ice cream from the container by a plunger of a distributor (i.e., depressing device) onto an individual container.

The container as well as the method disclosed the above-cited Gazette relies on compressing the container from above by the plunger of the dispenser. With an advantageous consequence, it is possible to transfer the content food to the individual container more easily and reliably over the conventional scooping method.

However, the container used in this method can not function unless the container is injection- or sheet-molded using a considerable amount of synthetic resin. As a result, the container after compressed is relatively bulky and not easy for disposal thereof. From the economical viewpoint also, this proposal requires a relatively high cost.

In view of the problem as has been described above, the present invention aims to provide a food package and a method for forcing the content food out from the package allowing distribution to be achieved in the low cost but reliable package form and allowing the content food to be easily forced out by a push-out device, leaving the flattened container which is not bulky and convenient for disposal thereof.

### SUMMARY OF THE INVENTION

The object set forth above is achieved, according to one aspect of the invention, by a food package comprising a container made of soft material, which is provided at its bottom with a push-out aperture and filled with viscous or semisolid food (referred to hereinafter simply as food unless otherwise specified) such as ice cream, ice milk or frozen yogurt and, according to another aspect of the invention, by a method for pushing the content out from this food package using a push-out device.

Specifically, a food package according to the present invention comprises a container made of soft material and having a trunk substantially shaped in a cylinder, a truncated cone or an inverted truncated cone, and a bottom formed in its substantially central zone with a push-out aperture provided with a removable seal, and filled with viscous or semisolid food wherein the container has a sealed upper opening.

The trunk of the container made of soft material may be provided with annular bulges or annular grooves or annular steps arranged in parallel to the bottom.

The trunk of the container made of soft material may be provided with, in addition to the annular steps, bias-like bulges obliquely crossing these annular steps and having a uniform thickness as viewed in cross-section.

The bottom is provided around the push-out aperture with a leg extending downward.

The trunk of the container made of soft material may be provided with the annular bulges or the annular grooves or the annular steps arranged in parallel to the bottom.

The trunk of the container made of soft material may be provided with, in addition to the annular steps, bias-like bulges obliquely crossing these annular steps and having a uniform thickness as viewed in cross-section.

Push-out method for food from such food package comprises steps of: providing a push-out device comprising a container receiving member having a substantially cylindrical trunk member and a bottom member provided in its central zone with a through-hole, and a depressing member adapted to be guided into the cylindrical trunk member from above; setting the food package according to claim 1 in the container receiving member; compressing the food package by the depressing member from above toward the bottom while the container made of soft material is controllably guided along the inner surface of the cylindrical trunk member or a peripheral surface of the through-hole of the bottom member so that the container may be prevented from shifting sideways until the container is flattened; and thereby forcing out the content food through the push-out aperture and the through-hole of the bottom of the container made of soft material.

Alternatively, such push-out method for food from such food package may comprise steps of providing a push-out device comprising a substantially flat container receiving member formed in its substantially central zone with a through-hole and around the through-hole with a substantially annular groove or a substantially annular pedestal, and a depressing member positioned above the container receiving member and adapted to depress the container toward the container receiving member; removing the sealing member sealing the push-out aperture of the bottom of the food package according to claim 1 and setting the leg extending downward from the bottom in the substantially annular groove or the substantially circular pedestal; compressing the food package by the depressing member from above toward the bottom without anxiety that the package might shift sideways until the package is flattened; and forcing the content food through the push-out aperture of the bottom of the container made of soft material and the through-hole of the container receiving member.

### BRIEF DESCRIPTION OF THE DRAWINGS

FIG. 1(i), (ii) and (iii) are front views showing food package according to the invention shaped in different shapes; FIG. 2 is a perspective view showing the food package according to the invention using the container shaped in inverted truncated cone;

FIG. 3 is a front view showing the food package according to the invention using the container formed on the trunk with a plurality of annular bulges arranged in parallel to the bottom;

FIG. 4 is a front view showing the food package according to the invention using the container formed on the trunk with a plurality of annular steps having diameters gradually reduced toward the bottom;

FIG. 5 is a sectional view of such food package;

FIG. 6 is a front view showing the food package according to the invention using the container formed with, in addition to the annular bulges or grooves, a plurality of bias-like bulges obliquely crossing the annular bulges or grooves;

FIG. 7 is a sectional view of such food package;

FIG. 8 is a sectional view showing the push-out device in which the food package is set;

FIG. 9(i) and (ii) are sectional views showing the food package set in the annular groove of the bottom member before and after the package is compressed;

FIG. 10(i), (ii) and (iii) are front views showing the food package made of soft material according to the invention having different shapes, respectively;

FIG. 11 is a perspective view showing the food package according to the invention using the inverted truncated cone-shaped container;

FIG. 12 is a front view showing the food package according to the invention using the container formed on the trunk with a plurality of annular bulges arranged in parallel to the bottom;

FIG. 13 is a front view showing the food package according to the invention using the container formed on the trunk with a plurality of annular steps having diameters gradually reduced toward the bottom;

FIG. 14 is a sectional view of such food package;

FIG. 15 is a perspective view showing push-out means;

FIG. 16 is a front view showing the food package using the container formed on the trunk with, in addition to the annular bulges shown in FIGS. 13 and 14, a plurality of bias-like bulges obliquely crossing the annular bulges;

FIG. 17 is a sectional view showing such food package;

FIG. 18 is a sectional view showing the push-out device in which the food package is set; and

FIG. 19 is a sectional view showing an alternative embodiment of the push-out device in which the food package is set.

Identification of reference numerals used in the drawings is as follows;

A food package

B, B′ push-out device

a container made of soft material

b lid

c bottom

d sealing member

e substantially cylindrical trunk

I,I′ bottom member

g container receiving member

h depressing member

i supporting member

x push-out means

g depressing member

g₁ depressing disc

g₂ depressing rod

g₃ recess

1 trunk

2 annular bulges

3 annular steps

4 bias-like bulges

5, 9 flange

6, 8, 10 push-out aperture

7 leg

11 flared through-hole

12 peripheral edge

13 peripheral edge portion

14 annular grooves

15 side wall

16 individual container

21 push-out aperture

22 annular leg

23 push-out plate

24 protection cylinder

25 annular groove

26 supporting member

27 circular pedestal

### PREFERRED EMBODIMENTS OF THE INVENTION

The food package according to the present invention comprises a container made of soft material (referred to hereinafter simply as container unless otherwise specified) filled with viscous or semisolid food such as ice cream, ice milk or frozen yogurt. This container is preferably molded from synthetic resin such as polyethylene, polypropylene or polyester, paperboard coated with said synthetic resin or laminated paper consisting of paperboard and synthetic resin film.

The container may take a general shape of cylinder having a uniform diameter from its upper end to its lower end or inverted truncated cone having a diameter gradually reduced from its upper end to its lower end or truncated cone having a diameter gradually enlarging from its lower end to its upper end. However, the container is preferably shaped in the inverted truncated cone since this shape enables a residual quantity of the content food to be minimized after the container has been compressed by the depressing member as will be described more in detail.

The trunk is provided at its lower end with a bottom which is,in turn, provided in its substantially central zone with a push-out aperture. The content food is forced out from the container through this push-out aperture. This aperture has a decorative shape such as circular shape or star-like shape and normally, for example, in the course of distribution, sealed with a sealing member from the exterior. The sealing member is formed, for example, by a laminated sheet consisting of aluminum foil and synthetic resin film and removed immediately before the content food is pushed out.

This container may be provided with a leg extending downward from the bottom around said push-out aperture. The leg may be formed by a downward extension of the trunk contiguous to the lower end of the trunk or provided on the lower side of the bottom. In this case, the leg has a diameter smaller than a diameter of the trunk and is molded together with the container.

The container is preferably formed on its trunk with, in addition to the annular bulges or the annular steps, a plurality of bias-like bulges. These bias-like bulges obliquely cross the annular bulges or the annular steps and have a uniform thickness as viewed in cross-section. These annular bulges, annular steps and bias-like bulges form fold lines along which the food package is collapsed as the package is compressed by the depressing member as will be described later.

After such container has been filled with food, the upper opening is sealed with a lid or tightly covered with a covering lid to form the food package.

The lid may comprise paperboard or aluminum foil as basic material laminated with synthetic resin film or coated with synthetic resin. In the case of the covering lid, this is preferably molded from synthetic resin or the like.

To force the content food out from the food package as has been described above, a push-out device designed exclusively for such food package. This push-out device comprises a container receiving member and a depressing member. The former includes a substantially cylindrical trunk member and a bottom member provided in its central zone with a through-hole. The latter is adapted to be forced into the cylindrical trunk member.

When this push-out device is used to force the content food out from the food package, the sealing member sealing the push-out aperture is peeled off from the bottom of the container. Then, the food package is set in the container receiving member with the lid maintained to seal the container and compressed by the depressing member from above toward the bottom. The container is progressively flattened from the lower side and the content food is forced out through the push-out aperture of the bottom and the through-hole of the container receiving member. In this way, the content food is transferred to the individual container underlying the through-hole.

In the course of compressing the food package using the push-out device to force out the content food, it is not apprehended that the container might shift sideways. More specifically, the container is controllably guided along the inner surface of the container receiving member so that the container is smoothly compressed until it is completely flattened. The container is provided on its trunk with the annular bulges or the annular grooves arranged in parallel to the bottom. More preferably, the trunk is provided with, in addition to such bulges or grooves, the bias-like bulges obliquely crossing them and having a uniform thickness as viewed in cross-section. Such arrangement ensures that these bulges or grooves form the fold lines along which the container is collapsed and thereby the content food is forced out as completely as possible.

The container flattened in this manner is not bulky and convenient for disposal thereof.

The push-out device may comprise a substantially cylindrical trunk and a flat supporting member. The supporting member may be provided in its substantially central zone with a through-hole and around this through-hole with an annular groove or a circular pedestal. To force the content food out from the package using this push-out device, first of all, the sealing member is peeled off from the push-out aperture of the package bottom. Then, the food package is set in the device with the leg of the package engaged with the annular groove or the outer peripheral surface of the circular pedestal. The push-out aperture of the food package is aligned with the through-hole of the supporting member as the food package is set in the push-out device.

The food package set in the device and having its upper opening sealed with the lid is compressed by the depressing member of the push-out device from above toward the bottom. The content food is forced out through the push-out aperture and the through-hole and transferred to the individual container as the food package is progressively collapsed from its lower side. In this course, the food package (i.e., container) is smoothly compressed until it is completely flattened without shifting sideways and the content food is force out as completely as possible. This is for the reason that the leg of the food package (i.e., container) is held in engagement with the annular groove or the outer peripheral surface of the circular pedestal.

### EXAMPLES

Details of the food package, the method and the device according to the present invention will be more fully understood from the description given hereunder in reference with the accompanying drawings.

A food package (A) according to the present invention comprises a container (a) as shown by FIG. 2 filled with viscous or semisolid food such as ice cream, ice milk or frozen yogurt and a lid (b) adapted to seal an opening of the container(a).

A trunk (1) as well as a bottom (c) of the container (a) is preferably molded from soft material, for example, synthetic resin such as polyethylene, polypropylene or polyester, paperboard coated with said synthetic resin or laminated paper consisting of paperboard and synthetic resin film. This container (a) has none of legs extending downward from the bottom (c).

The lid (b) is provided in the form of a sealed lid molded from paperboard or aluminum foil as its basic material and laminated or coated with synthetic resin film. It is also possible to provide the lid (b) in the form of a covering lid.

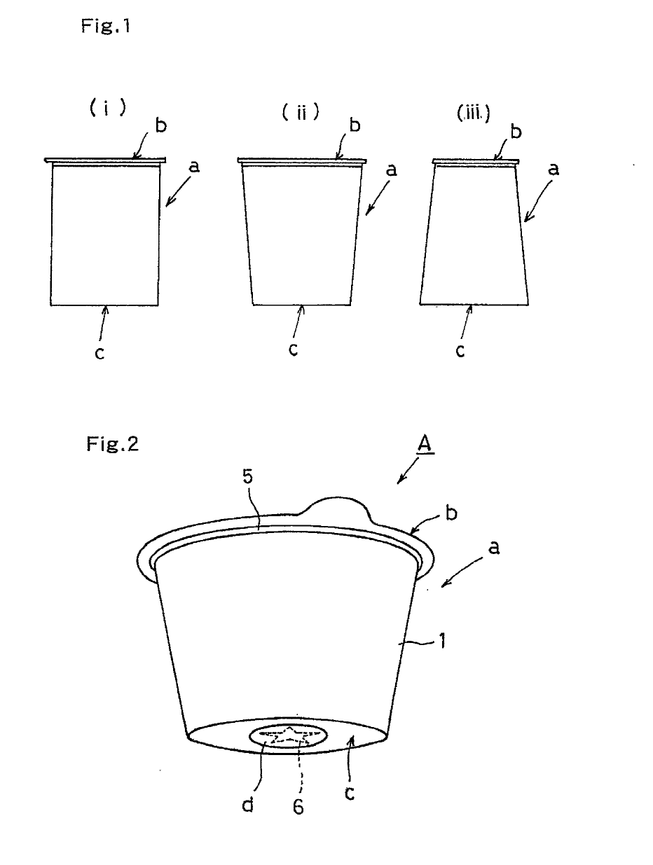

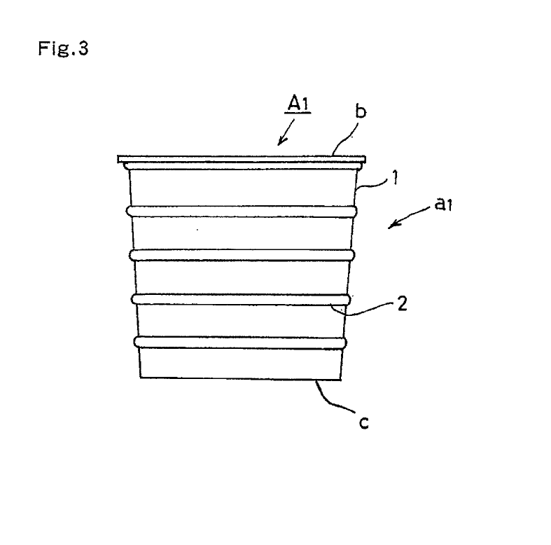

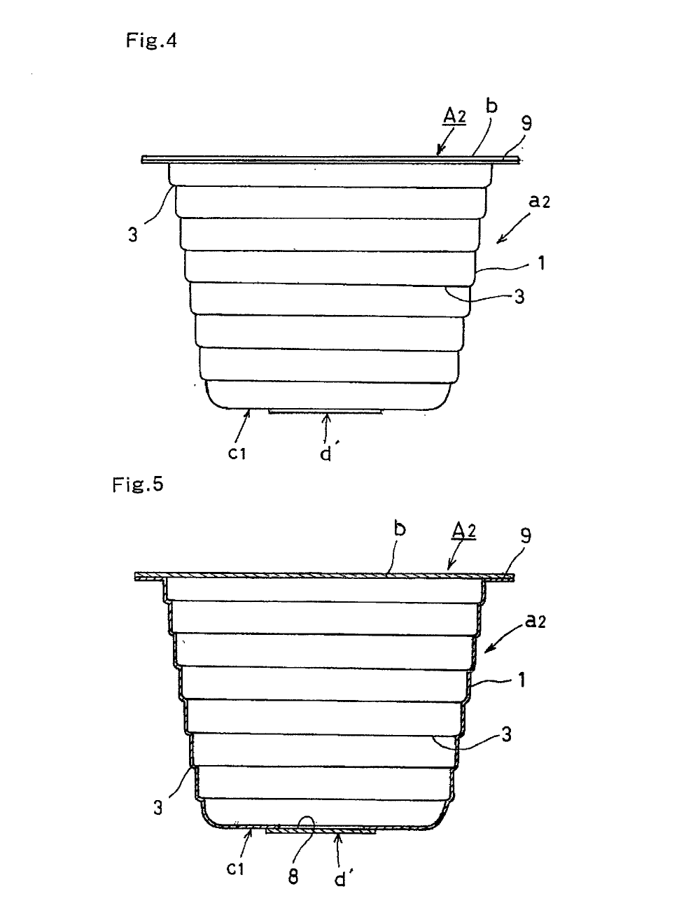

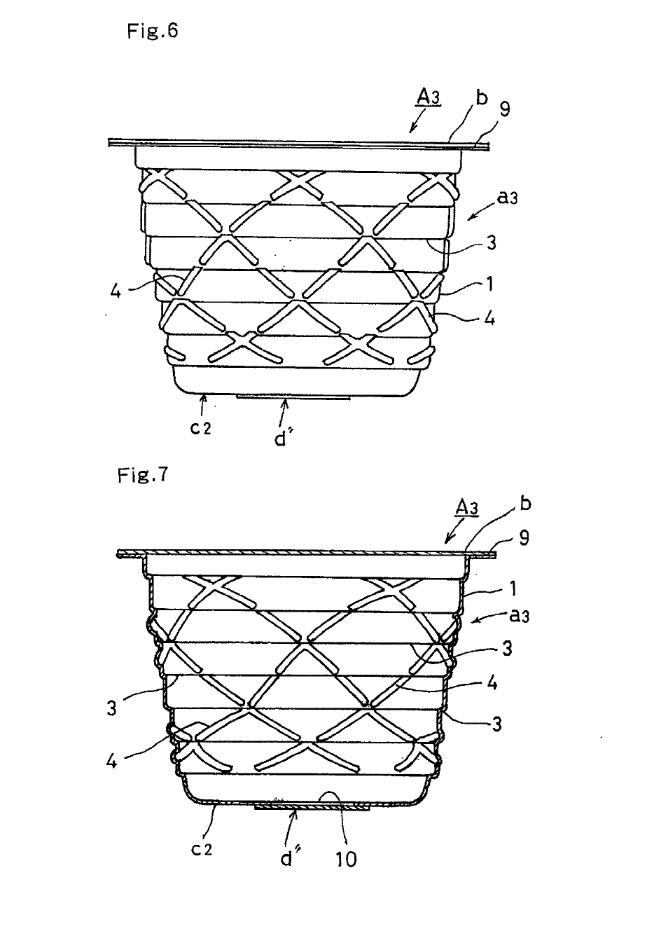

The container (a) molded from soft material may take a general shape of (i) cylinder; (ii) inverted truncated cone; or (iii) truncated cone as shown in FIG. 1. The trunk (1) has its peripheral surface which may be flat as seen in FIG. 2 or may have a plurality of annular bulges (2) or grooves as seen in FIG. 3. These annular bulges (2) or grooves extend in parallel to the bottom (c). Alternatively, the trunk (1) may have a stepwise profiled surface defined by a plurality of steps (3) as shown in FIGS. 4 and 5. It is also possible to form the peripheral surface shown in FIGS. 4 and 5 additionally with a plurality of bulges (4) obliquely crossing the steps (3) as shown in FIGS. 6 and 7. These bulges (4) have a uniform thickness in cross-section thereof.

These annular bulges (2), steps (3) or the bulges (4) obliquely crossing the steps (3) are destined to function as fold lines along which the container (a) is collapsed. As will be described later, these fold lines facilitate the container (a) to be collapsed by a pressure disc of a push-out device in order to force the food out from the container (a).

Soft material used to mold the container (a) may be selected depending on the desired shape of the container (a). The container (a) of the food package (A) shown in FIG. 2 is molded into an inverted truncated cone using soft material comprising paperboard coated or laminated with synthetic resin. This container (a) basically comprises the trunk (1) having flat surface and the bottom (c). The trunk (1) defines an upper opening provided with a flange (5) which is sealed with the lid (b) after the container (a) has been filled with food. The bottom (c) is formed in its substantially central zone with the push-out aperture (6) which is, for example, star-shaped and sealed with a sealing member (d) from the exterior. The bottom (c) is provided with none of legs extending downward.

The container (a₁) of the food package (A₁) shown in FIG. 3 is molded using the same soft material as that used for molding the container (a) of FIG. 2. This container (a₁,) is similar to the container (a) of FIG. 2 in the arrangement as follows: the trunk (1) is formed the annular bulges (2) extending in parallel to the bottom (c); the lid (b) is sealed after the container (a₁,) has been filled with food, and the bottom (c) is formed in its substantially central zone with the push-out aperture, for example, of star-shape which is sealed with a sealing member from the exterior.

The container (a₂) of the food package (A₂) shown in FIGS. 4 and 5 is injection-molded using the above-described synthetic resin. The trunk (1) is formed, in parallel to the bottom (c₁) with a plurality of outwardly protruding annular steps (3). The annular steps (3) are arranged so that each of them has a diameter gradually reduced as it gets nearer to the bottom (c₁).

After the container (a₂) has been filled with food, the lid (b) is sealed to a flange (9). The bottom (cl) is provided in its substantially central zone with a push-out aperture (8) which is, for example, star-shaped and sealed with a sealing member (d′) from the exterior.

The container (a₃) of the food package (A₃) shown in FIGS. 6 and 7 is injection-molded using synthetic resin similarly to the container (a₂) shown in FIGS. 4 and 5. The trunk (1) is formed with, in addition to the annular steps (3) arranged in parallel to the bottom (C₂), hollow bulges (4), (4) obliquely crossing the steps (3). These hollow bulges (4), (4) have a uniform thickness as viewed in cross-section thereof.

This container (a₃) is similar to those which have been described above except for the bulges crossing the steps (3). Specifically, the lid (b) is sealed to the flange (9) after the container (a₃) has been filled with food. The bottom (c₂) is provided in its substantially central zone with a push-out opening (10) which is, for example, star- shaped and sealed with a sealing member (d′) from the exterior.

Now a push-out device (B) used to force the content food out from the food package (A) will be discussed.

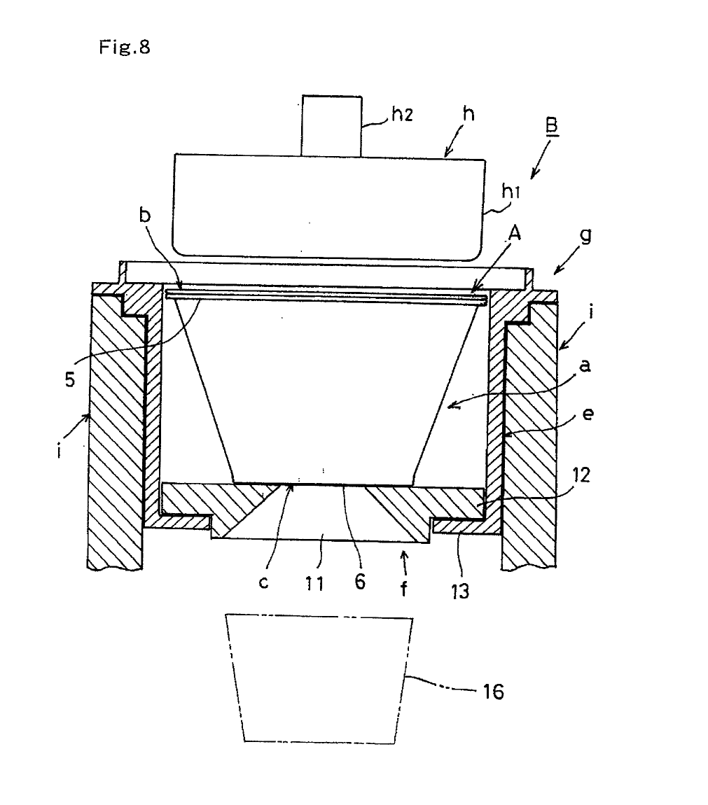

As will be apparent from FIG. 8, the device (B) basically comprises a container receiving member (g) and a depressing member (h). The container receiving member (g) includes a substantially cylindrical trunk member (e) and a bottom member (f) provided in its substantially central zone with a flared through-hole (11). The depressing member (h) is forced into the trunk (e) from above.

In this push-out device (B), the substantially cylindrical trunk (e) of the container receiving member (g) has its flange-like upper end supported by a support member (i) from below.

The bottom member (f) as the component of the container receiving member (g) is suspended on a peripheral edge (13) extending inward from a lower end of the substantially cylindrical trunk (e).

The depressing member (h) positioned above the container receiving member (g) comprises a depressing disc (h₁) and a depressing rod (h₂). The depressing disc (h₂) is positioned in parallel to the bottom member (f) with the center of the disc (h₁) lying immediately above the center of the bottom member (±)

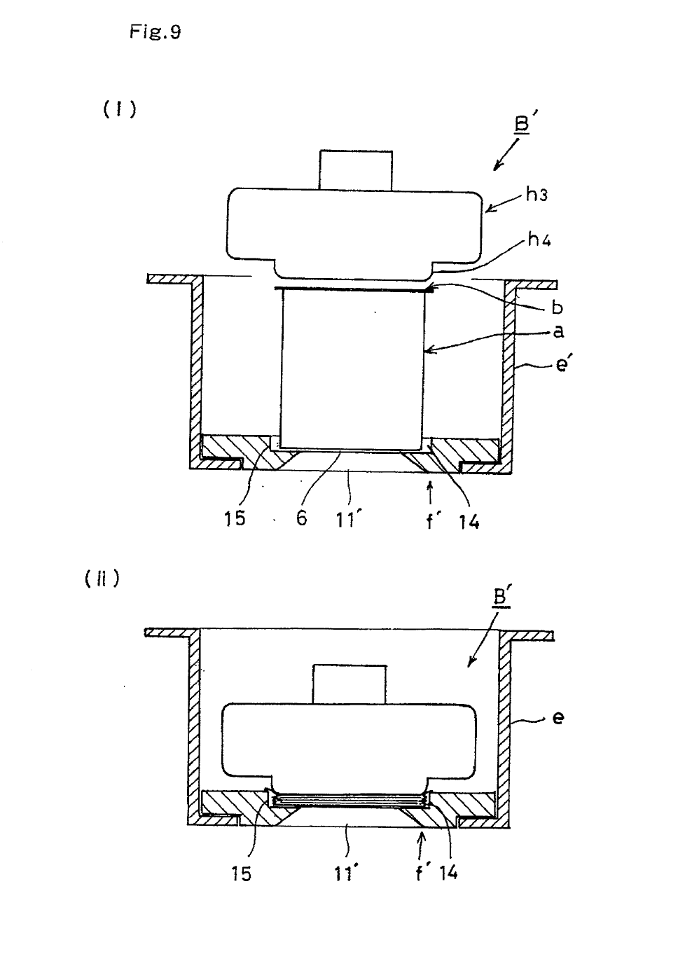

FIG. 9 shows the push-out device (B′) according to another embodiment before the container is collapsed (i) and after the container has been collapsed (11) by the device (B′).

In this push-out device (B′) also, the bottom member (f′) is provided in its central zone with the flared through hole (11′). The inner peripheral surface of its upper part is formed with an annular groove (14) defining a difference in level. The depressing disc (h₃) adapted to be forced into the trunk (e′) is formed with a protuberance (h₄) extending downward and shaped substantially in conformity with the annular groove (14).

It will be now described how the content food is forced out from the food package (A) using the push-out device (B).

FIG. 8 shows the typical food package (A) of cup-type set in the push-out device (B). To force the content food out, the sealing member (d) is peeled off from the push-out aperture (6) extending through the bottom (c) of the container (a) prior to setting the food package (A) in the push-out device (B).

The container (a) set in the device (B) has its bottom (c) resting on the bottom member (f). Thereupon, the push-out aperture (6) of the bottom (c) is aligned with the flared through-hole (11). At the same time, the peripheral flange (5) of the upper opening is controllably guided along the inner surface of the substantially cylindrical trunk (e). Therefore, it is not apprehended that the container (a) might shift sideways with respect to the direction in which the container (a) is depressed. In this manner, the container (a) is successively flattened from its lower end as the content food is forced out through the push-out aperture (6) of the bottom (c).

The content food is completely forced out and transferred to an individual container (16) as the container (a) is flattened in this manner.

It is assumed now that the push-out device (B) shown in (i) and (ii) of FIG. 9 is used to force the content food out from the container (a). The cylindrical container (a) shown by (i) in FIG. 1 is set in the push-out device (B) with the bottom of the trunk (1) of the container (a) being engaged in the annular groove (14). Then the container (a) is compressed by the depressing disc (h₃) having the protuberance (h₄) extending downward and shaped substantially in conformity with the groove (14). In the course of this compression, the lower peripheral surface of the trunk (1) is controllably guided along the inner peripheral surface (15) of the annular groove (14). In this way, the content food can be forced out through the push-out aperture (6) of the bottom (c) without an anxiety that the container (a) might shift sideways. The content food is thus completely transferred to the individual container as the container (a) is completely flattened.

The container (a) shown by FIG. 3 is formed with annular bulges (2) and the container (a₂) shown by FIGS. 4 and 5 is formed with the annular steps (3). The container (a₃) shown by FIGS. 6 and 7 is formed with the annular steps (3) arranged in parallel one to another. This container (a₃) is further formed with the bias-like bulges obliquely crossing the annular steps (3) and having a uniform thickness as viewed in the cross-section. Such unique arrangement facilitates the container (a) to be flattened. More specifically, the annular bulges (2), the annular steps (3) or the bias-like bulges (4) function as the fold lines. The container (a) is collapsed along these fold lines as the container (a) is compressed by the depressing disc (h₁) of the depressing device (B).

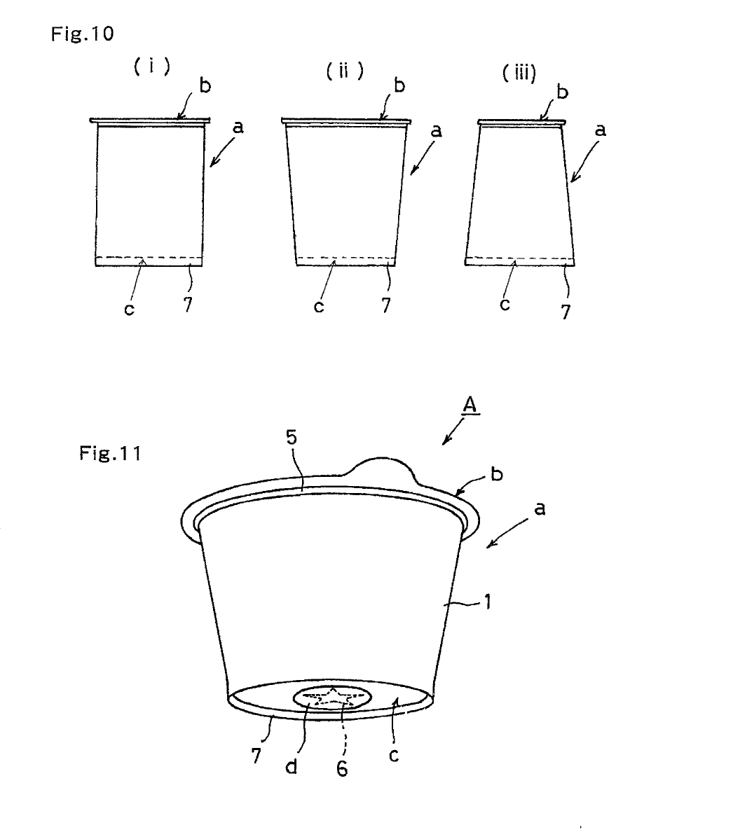

While the container having none of legs extending downward from the bottom (c) has been described hereinabove, it is also possible to use the container provided with such legs. For example, the container (a) shown by FIG. 10 is similar to the container (a) shown by FIG. 1 except that the trunk (1) extends downward beyond the bottom (c) to define a leg (7).

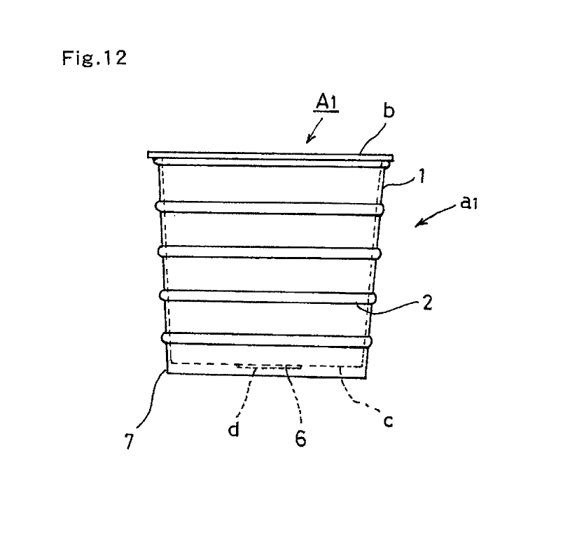

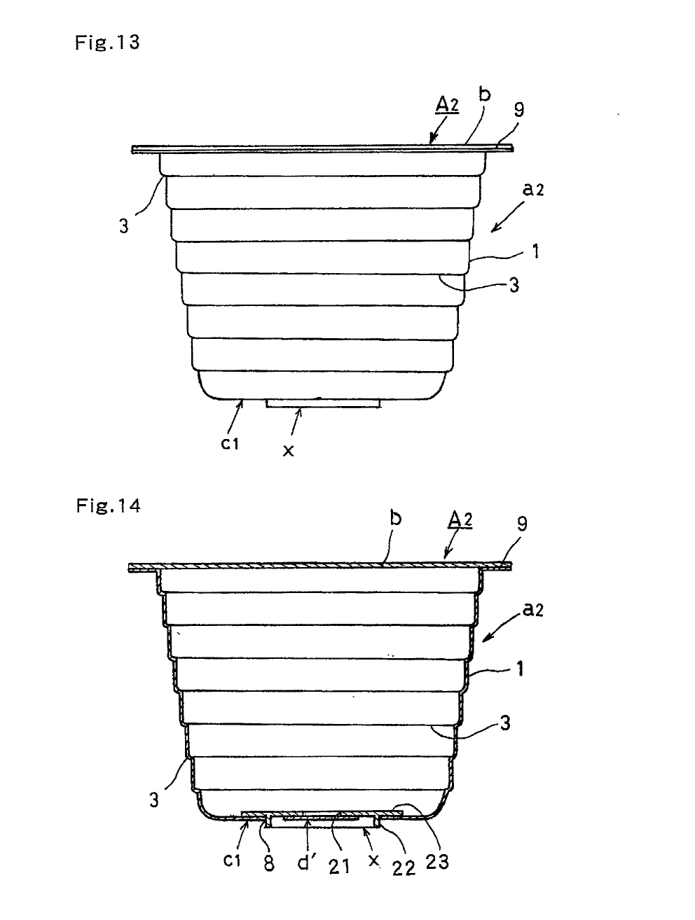

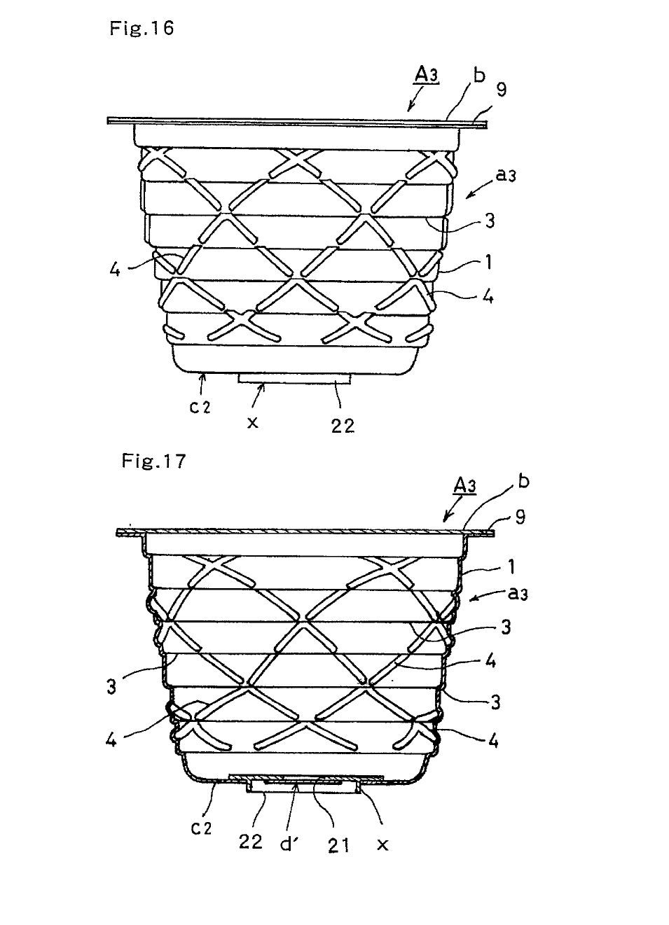

The container (a) shown by FIG. 11 is similar to the container (a) shown by FIG. 2 except that the trunk (1) extends downward beyond the bottom (c) to define a leg (7). The container (a) shown by FIG. 12 is similar to the container (a) shown by FIG. 3 except that the trunk (1) extends downward beyond the bottom (c) to define a leg (7). The container (a) shown by FIGS. 13 and 14 is similar to the container (a) shown by FIGS. 4 and 5 except that the trunk (1) extends downward beyond the bottom (c) to define a leg (7). The container (a) shown by FIGS. 16 and 17 is similar to the container (a) shown by FIGS. 6 and 7 except that the trunk (1) extends downward beyond the bottom (c) to define a leg (7).

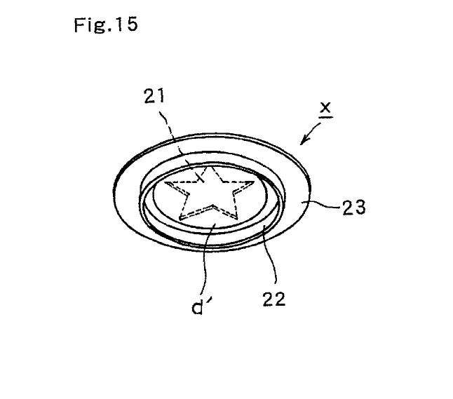

In the container (a₂) of the food package (A₂) shown by FIGS. 13 and 14, the bottom (cl) itself is formed in its central zone with a relatively large through-hole (8). Push-out means (x) shown by FIG. 15 is welded to this through-hole (8) from the inner side of the container (a₂).

The push-out means (x) comprises a push-out plate (23) formed in its central zone with a star-shaped push-out aperture (21) and along its peripheral edge with an annular leg (22) extending downward.

To attach the push-out means (x) to the bottom (c), the push-out means (x) is engaged with the through-hole (8) of the container (a₂) from the inside. Then, the portion of the push-out plate (11) extending around the annular leg (22) is welded to the inner surface of the bottom (c₁).

The star-shaped push-out aperture (21) is sealed with the sealing member (d′) comprising aluminum foil laminated with synthetic resin film.

In the food package (A₃) shown by FIGS. 16 and 17, the bottom (c₂) of the container (a₃) is provided with the push-out means (x) and the push-out aperture (21) defined inside the annular leg (22) is sealed with the sealing member (d′) from the exterior.

Now the push-out device (B) adapted to be used with the container provided with the leg extending downward from its bottom will be described.

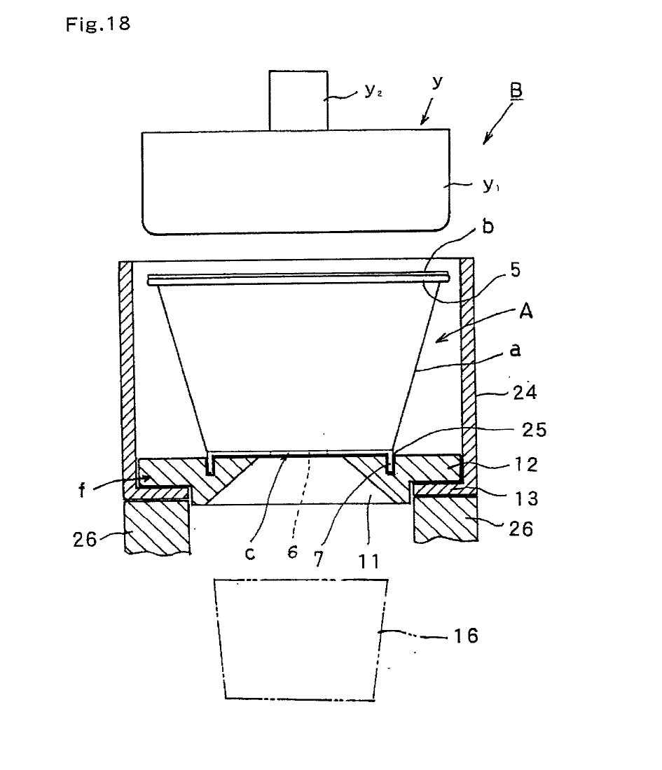

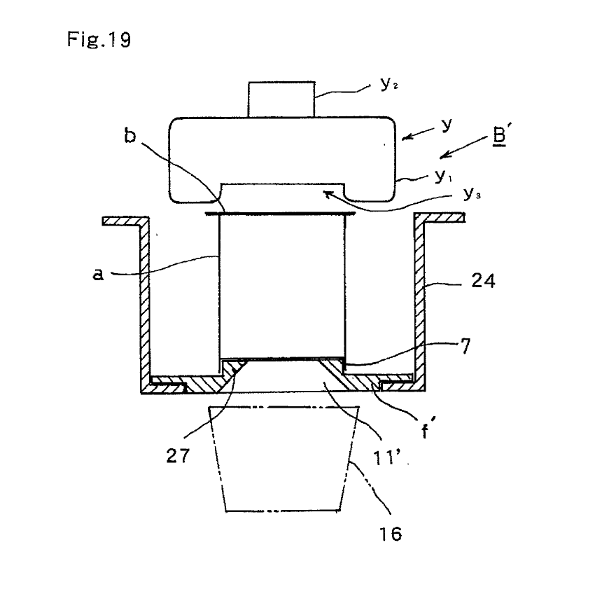

The push-out device (B) shown by FIGS. 18 and 19 is substantially similar to that shown by FIGS. 8 and 9. The device (B) comprises a protection cylinder (24), a container supporting member (f) and a depressing member (y).

The depressing member (y) of this push-out device (B) illustrated to be positioned above the container (a) comprises a depressing disc (Y₁) and a depressing rod (Y₂) These depressing disc (y₁) and container supporting member (f) are in parallel to each other in center-aligned relationship. The container supporting member (f) is formed in its central zone with a through-hole (11) flared downward and outside the through-hole (11) with an annular groove (25).

The container supporting member (f) has its peripheral edge portion (12) resting on a lower flange (13) of the protection cylinder (24). The member (f) is thus supported together with this flange (13) by the underlying supporting member (26).

FIG. 19 shows an alternative embodiment of the push-out device (B). In this embodiment, the container supporting member (f′) is formed in its central zone with a through-hole (11′) flared downward and around the through-hole (11′) with a circular pedestal (27). A depressing disc (Y₁) adapted to be forced into the protection cylinder (24) is formed in its central zone with a recess (y₃) which has a diameter substantially corresponding to a diameter of the circular pedestal (27) of the container supporting member (f′).

To force the content food out from the food package (A) using the push-out device (B). the depressing member (y) is lowered so that the depressing disc (Y1) may bear against and depress the sealed lid (b) of the container (a).

In the course of compression, the upper surface of the container supporting member (f) and the depressing disc (Y₁) are in center-aligned relationship. In addition, the leg (7) of the container (a) is in engagement with the annular groove (14) of the container receiving member (f). Consequently, the container (a) is progressively flattened from its lower end without any no anxiety that the container (a) might shift sideways. In this way, the content food is forced out through the push-out aperture (6) and the flared through-hole (11) and transferred to the individual container (16).

To force the content food out from the food package using the push-out device (B′) shown by FIG. 19, the depressing member (y) is lowered so that the depressing disc (y₁) may bear against and depress the sealed lid (b) of the container (a). In the course of compression, the leg (7) of the container (a) is in engagement with the circular pedestal (27). Consequently, the container (a) is progressively flattened from its lower end without any no anxiety that the container (a) might shift sideways. The depressing disc (Y₁) depressed into the protection cylinder (24) is formed in its central zone of the compression surface with the recess (y₃) which has a diameter substantially corresponding to a diameter of the circular pedestal (27). Such unique arrangement ensures that the content food can be completely forced out through the push-out aperture (6) and the through-hole (11′) and transferred to the individual container (16).

In the embodiments of the food package, the container (a₁) shown by FIG. 12 is formed with the annular bulges (2) and the container (a₂) shown by FIGS. 13 and 14 is formed with the annular steps (3). The container (a₃) shown by FIGS. 16 and 17 is formed with, in addition to the annular steps (3), the bias-like bulges (4) obliquely crossing the annular steps (3). These bias-like bulges (4) have a uniform thickness as viewed in cross-section. These annular bulges (2), steps (3) or the bulges (4) obliquely crossing the steps (3) are destined to function as fold lines along which the container (a) is collapsed. These fold lines facilitate the container to be collapsed by a pressure disc of a push-out device in order to force the food out from the container.

### Effect of the Invention

The food package according to the present invention comprises the container made of soft material, filled with viscous or semisolid food such as ice cream and then sealed. Therefore, the food package can be reliably distributed at a low cost. Using the push-out device exclusively developed to be used with this food package, the container can be easily flattened to force out and to transfer the content food to the individual container.

The container made of soft material is formed on its trunk with the annular bulges or the annular steps functioning as the fold lines. The food package is flattened along these fold lines to force the content food out entirely as the package is depressed from the lid toward the bottom. The container having been flattened in this manner is stabilized in sufficiently compact state to facilitate disposal thereof.

Setting the food package in the protection cylinder of the container receiving member of the push-out device and compressing this by the depressing disc can be stably performed. This is for the reason that, in the course of such operation, the lower peripheral surface of the trunk is controllably guided along the inner peripheral surface of the annular groove. In this way, the content food can be forced out through the push-out aperture of the bottom without an anxiety that the container might shift sideways. The content food is thus completely transferred to the individual container as the container is completely flattened. The container flattened in this manner is not bulky and facilitates its disposal.

What is claimed is:

1. A food package comprising a container made of soft material and having a trunk substantially shaped in a cylinder, a truncated cone or an inverted truncated cone, and a bottom formed in its substantially central zone with a push-out aperture provided with a removable seal, and filled with viscous or semisolid food wherein the container has a sealed upper opening.

2. The food package according to claim 1, wherein the trunk of the container made of soft material is provided with annular bulges or annular grooves or annular steps arranged in parallel to the bottom.

3. The food package according to claim 2, wherein the trunk of the container made of soft material is provided with, in addition to the annular steps, bias-like bulges obliquely crossing these annular steps and having a uniform thickness as viewed in cross-section.

4. The food package according to claim 1, wherein the bottom is provided around the push-out aperture with a leg extending downward.

5. The food package according to claim 4, wherein the trunk of the container made of soft material is provided with the annular bulges or the annular grooves or the annular steps arranged in parallel to the bottom.

6. The food package according to claim 5, wherein the trunk of the container made of soft material is provided with, in addition to the annular steps, bias-like bulges obliquely crossing these annular steps and having a uniform thickness as viewed in cross-section.

7. Push-out method for food from the food package according to claim 1 comprising steps of;
providing a push-out device comprising a container receiving member having a substantially cylindrical trunk member and a bottom member provided in its central zone with a through-hole, and a depressing member adapted to be guided into the cylindrical trunk member from above;
setting the food package according to claim 1 in the container receiving member;
compressing the food package by the depressing member from above toward the bottom while the container made of soft material is controllably guided along the inner surface of the cylindrical trunk member or a peripheral surface of the through-hole of the bottom member so that the container may be prevented from shifting sideways until the container is flattened; and
thereby forcing out the content food through the push-out aperture and the through-hole of the bottom of the container made of soft material.

8. Push-out method for food from the food package according to claim 1 comprising steps of:
providing a push-out device comprising a substantially flat container receiving member formed in its substantially central zone with a through-hole and around the through-hole with a substantially annular groove or a substantially annular pedestal, and a depressing member positioned above the container receiving member and adapted to depress the container toward the container receiving member;
removing the sealing member sealing the push-out aperture of the bottom of the food package according to claim 1 and setting the leg extending downward from the bottom in the substantially annular groove or the substantially circular pedestal;
compressing the food package by the depressing member from above toward the bottom without anxiety that the package might shift sideways until the package is flattened; and
forcing the content food through the push-out aperture of the bottom of the container made of soft material and the through-hole of the container receiving member.

9. A push-out device comprising a container receiving member having a substantially cylindrical trunk member and a bottom member provided in its central zone with a through-hole, and a depressing member adapted to be guided into the cylindrical trunk member from above, said push-out device being characterized by that:
the container receiving member comprising therein:
space adapted to receive the food package according to claim 1; and
inner structure arranged so that the inner surface of the cylindrical trunk member or the peripheral surface of the through-hole of the bottom member controllably guides the container made of soft material to avoid the anxiety that the container might shift sideways as the food package is compressed by the depressing member from above toward the bottom until the container is flattened and thereby the content food is forced out through the push-out aperture of the bottom of the container made of soft material and the through-hole of the bottom member.

10. A push-out device comprising a substantially flat container receiving member formed in its substantially central zone with a through-hole and around the through-hole with a substantially annular groove or a substantially annular pedestal, and a depressing member positioned above the container receiving member and adapted to depress the container toward the container receiving member, said push-out device being characterized by that:
the container receiving member comprising therein:
space allowing the food package according to claim 1 having the sealing member removed from the push-out aperture of the bottom to be set in the container receiving member with the leg extending downward from the bottom engaged with the substantially annular groove or the substantially annular pedestal; and
an inner structure arranged so that the food package is flattened without the anxiety that the food package might shift sideways as the package is compressed by the depressing member from above toward the bottom and thereby the content food is forced out through the push-out aperture of the bottom of the container and the through-hole of the bottom member.
